(19) United States
(12) Patent Application Publication
(10) Pub. No.: US 2023/0371472 A1
(43) Pub. Date: Nov. 23, 2023

(54) ANIMAL LEASH APPARATUS

(71) Applicant: Adam Davis, Hercules, CA (US)

(72) Inventor: Adam Davis, Hercules, CA (US)

(21) Appl. No.: 18/095,122

(22) Filed: Jan. 10, 2023

Related U.S. Application Data
(60) Provisional application No. 63/343,312, filed on May 18, 2022.

(51) Int. Cl. A01K 27/00

(52) U.S. Cl. CPC A01K 27/003

(57) ABSTRACT

An animal leash apparatus, attachable to a pet, includes an elongated flexible member or leash and an elongated outer member. The elongated outer member imparts rigidity to an elongated, distal portion of the elongated flexible member or leash, and is configured to maintain a predetermined shape and thereby maintain the elongated flexible member in the predetermined shape such that the elongated flexible member and elongated outer member extend away from a pet's legs. The elongated flexible member may include a clip, facilitating securing the elongated flexible member to a pet collar or harness. The elongated flexible member may include a handle, facilitating grasping the elongated flexible member by a user.

### CROSS-REFERENCE TO RELATED APPLICATIONS

This application claims the benefit of U.S. Provisional Patent Application No. 63/343,312, filed on May 18, 2022, which is incorporated herein by reference in its entirety.

### FIELD OF THE INVENTION

The present invention relates generally to a leash apparatus, and more particularly, to an animal leash apparatus.

### BACKGROUND OF THE INVENTION

A leash (also called a lead, lead line or tether) is a rope or similar material used to control an animal by attaching the leash to a collar, harness, or halter, which in turn is fitted onto the animal.

Leashes take many forms. In one example, a leash may consist of a simple metal chain. In another example, very short tab leashes may include a clip attached to a loop handle or to a short piece of leather with a knot or similar short handle; such short tab leashes allow close, tight control of a dog in certain competition or training situations. Short, soft, braided leather leashes are also known, which typically include a loop handle and a clip to attach to the collar; such leashes are usually about 4 feet in length, and are commonly used during obedience training, where the softness enables the trainer to fold the leash into a shorter length and the braiding allows a firmer grip. Nylon webbing leashes, also known as a tracking/training leash, are further known, and are usually 4 to 6 feet long and include a loop handle and clip; such leashes are most commonly used for walking dogs casually. Extended-length webbing leashes, which may be 12 to 30 feet long or even longer, also known as a tracking/training leashes, are further known; such leashes usually come with a loop handle and a clip, and are primarily used for training at a distance or during tracking sessions. In another example, slip-leashes, which usually include a loop handle and an adjustable, slipping loop at the other end that goes around the dog's neck, are often used in work or competitions—such as dog agility—where the leash must be quickly removed and replaced. In yet another example, retractable leashes, including a hook on a thin rope that retracts automatically into a large plastic handle, are further known; such leashes typically allow the dog to wander 15 or 25 feet away while keeping the leash taut (in theory preventing the leash from tangling around obstacles or the dog's legs) but still allowing the handler to reel in the dog for closer control.

Dog leashes are used to walk dogs in public places. Having the dog wear a leash is a way of protecting the dog and other persons (e.g., if the dog runs away and bites someone). Also, the length is one of the important aspects of the leash, as a correct length will allow for good control of the dog. The length of the leash must be chosen according to the size of the dog. Leashes should not be either too long or too short. Excessively long leashes do not allow for adequate control of the pet, which can result in unpleasant accidents with more aggressive dogs; in turn, excessively short leashes are uncomfortable for both the dog and the owner. The perfect leash allows to restrain the dog but at the same time is not viewed as a punishment for the pet.

High-quality dog leashes may be made of leather, nylon or even chain or other flexible materials, and typically include a quality metal clip. The metal clip must securely fasten to a metal ring on the collar or harness in order to maintain adequate control of the dog. The material of which the leash is made is not of great importance as long as the leash does not show evidence of wear or fraying. Therefore, leashes should be periodically checked to ensure they are maintained in proper condition.

Another important aspect of dog leashes is their sturdiness. Although rope leashes are quite inexpensive, they are vulnerable to chewing and fraying and are not amongst the most recommended types of leashes. It is considered that a better type of leash is the one made of nylon because this material provides a bit of elasticity which is meant to result in more comfort for the dog; however, on the other hand, nylon leashes can cause chafe or can cut into the skin of the dog.

Leather leashes are often preferred over nylon leashes because leather is more resistant, softer, and becomes more flexible with age. However, a downside of leather is that it is more prone to be chewed when compared to nylon.

Retractable dog leashes are amongst the most dangerous leashes for dogs because they allow dogs to wander excessively far from the owner or walker. Retractable leashes are usually made of nylon and the retractable device is made of plastic or a stronger composite. Although these leashes can be convenient for both the dog and the owner as they allow for some control, they make it difficult to keep a dog under control, which can result in persons or other dogs being attacked. Aggressive dogs should not be walked with a retractable leash, and puppies should be kept closely to ensure their protection from various dangers such as cars. Dogs with a tendency to bolt without warning should be walked with caution, as a retractable lead can allow the dog to accelerate to significant speed before being stopped suddenly presenting the possibility of injury to both dog and owner.

However, a slackened leash of any type may easily become entangled beneath a body of an animal. An animal may not be allowed to walk freely as a slackened leash may get tangled into the legs of an animal, or get stuck around the legs of an animal.

Accordingly, there is need for a solution to at least one of the aforementioned problems.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention is directed to an animal leash apparatus.

In an embodiment of the invention, an animal leash apparatus may include an elongated flexible member and an elongated outer member. The elongated flexible member may have a proximal end and a distal end. The proximal end may be engageable by a pet owner or user. The distal end may be configured for attachment to a collar or harness wearable by a pet. The elongated outer member may extend along and impart rigidity to an elongated, distal portion of the elongated flexible member. The animal leash apparatus may be configured to adopt a working configuration in which the proximal end of the elongated flexible member is held by a user located adjacent to a pet wearing the collar or harness, and the distal end of the elongated flexible member is attached to the collar or harness. In the working configuration, the elongated outer member may be arranged in a predetermined shape extending away from the pet's legs and may maintain the elongated flexible member along the predetermined shape and away from the pet's legs.

In an embodiment of the present invention, the predetermined shape may be curved. Alternative predetermined shapes (e.g., straight) are contemplated without departing from the scope of the present disclosure.

In an embodiment of the present invention, the elongated flexible member may be provided with a clip and a handle.

In an embodiment of the present invention, the clip may be connected with an end of the elongated flexible member.

In an embodiment of the present invention, the clip may be configured to be temporarily hooked with a collar or harness on an animal.

In an embodiment of the present invention, the handle may be connected with another end of the elongated flexible member.

In an embodiment of the present invention, the handle may be configured to be grabbed by a user or human.

In an embodiment of the present invention, the elongated flexible member may be connected between the clip and the handle.

In an embodiment of the present invention, the elongated flexible member may be removably or permanently attached to the elongated outer member.

In an embodiment of the present invention, the animal leash apparatus may further comprise an adhesive disposed between the elongated flexible member and the elongated outer member for added durability.

In an embodiment of the present invention, the elongated outer member may be located adjacent to the clip, such that the elongated outer member may be located closest to an animal when the clip is hooked with the collar or harness.

In an embodiment of the present invention, the animal leash apparatus may be a tangle free leash apparatus, as the elongated outer member may be stiffened or reinforced to minimize the tendency of a slackened leash to become entangled beneath a body of an animal.

In an embodiment of the present invention, the elongated outer member may allow an animal to walk freely by preventing the elongated flexible member from getting tangled into the legs of an animal, or at least make the elongated flexible member less likely to get stuck around the legs of an animal under the animal.

In an embodiment of the present invention, the elongated outer member may provide rigidity to the elongated flexible member such that the elongated flexible member may extend away from the pet's legs and be prevented from accidentally becoming tangled in the pet's legs.

In an embodiment of the present invention, the elongated outer member may be an elongated rigidly deformable sheath, and the elongated flexible member may be removably or permanently inserted into the elongated rigidly deformable sheath.

In an embodiment of the present invention, the elongated outer member may be made of, or comprise, a heat-shrink plastic tubing. The elongated flexible member or leash may extend through the outer member and the elongated outer member may be heat shrunk to conform to the elongated flexible member or leash.

In an embodiment of the present invention, the elongated outer member may comprise an elongated tube, a lengthwise channel, and a lengthwise slit.

In an embodiment of the present invention, the lengthwise channel may axially traverse through the elongated tube.

In an embodiment of the present invention, the lengthwise slit may laterally traverse into the lengthwise channel.

In an embodiment of the present invention, the elongated flexible member may be removably or permanently inserted into the lengthwise channel through the lengthwise slit.

In an embodiment of the present invention, the elongated outer member may further comprise an elongated wire element.

In an embodiment of the present invention, the elongated wire element may be removably or permanently inserted into the lengthwise channel through the lengthwise slit.

In an embodiment of the present invention, the elongated wire element may be encased in the elongated tube.

In an embodiment of the present invention, the elongated wire element may be coupled to the elongated flexible member.

In an embodiment of the present invention, the elongated wire element may be configured to provide rigidity and deformability to the elongated flexible member.

In an embodiment of the present invention, the elongated wire element may be inserted inside the elongated flexible member.

In an embodiment of the invention, the elongated wire element may be configured to impart elastic deformability to the elongated flexible member.

In an embodiment of the invention, the elongated wire element may be configured to impart plastic deformability to the elongated flexible member.

In an embodiment of the present invention, a user may shape a section of the elongated flexible member via the elongated wire element to ensure that the elongated flexible member stays away from legs of an animal.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

These and other objects, features, and advantages of the present invention will become more readily apparent from the attached drawings and the detailed description of the preferred embodiments, which follow.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

The preferred embodiments of the invention will hereinafter be described in conjunction with the appended drawings provided to illustrate and not to limit the invention, where like designations denote like elements, and in which:

FIG. 1 presents a perspective view of an animal leash apparatus of the present invention;

FIG. 2 presents an exploded view of an animal leash apparatus of the present invention;

FIG. 3 presents a perspective view showing that an elongated tube of an animal leash apparatus of the present invention may comprise heat-shrinkable plastic materials;

FIG. 4 presents a perspective view showing that an elongated outer member of an animal leash apparatus of the present invention may be deformed to an arched shape or a curved shape;

FIG. 5 presents a perspective view showing the animal leash apparatus in a working configuration, by which the animal leash apparatus of the present invention may prevent tangling of the animal leash apparatus with the pet dog's legs; and

FIG. 6 presents a front view showing the animal leash apparatus in the working configuration of FIG. 5.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

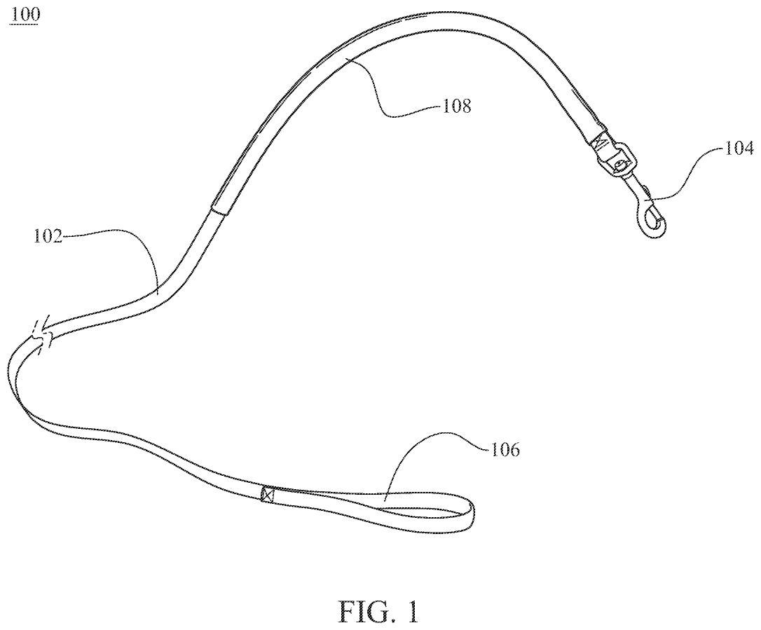

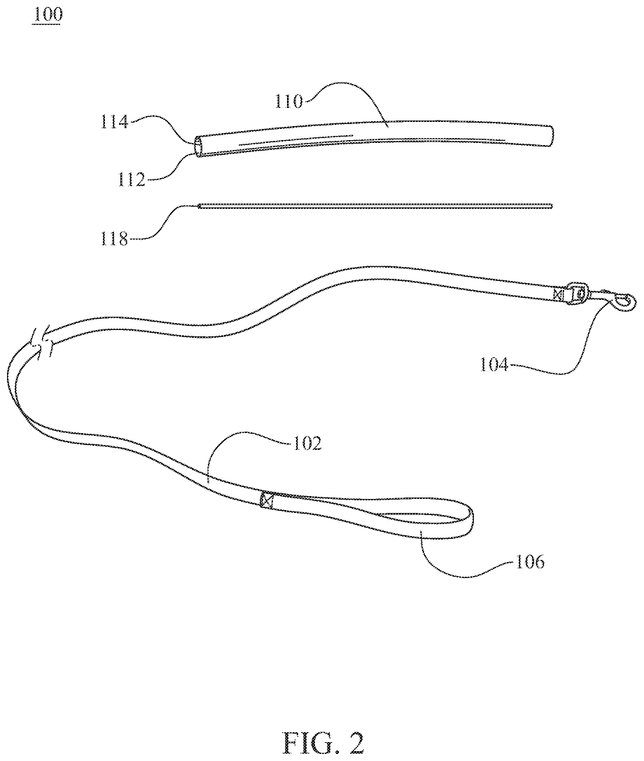

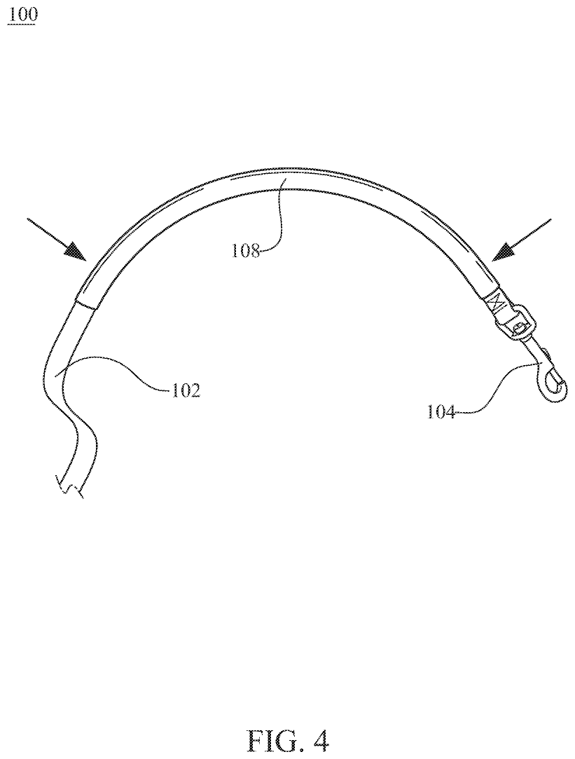

The present invention is directed toward an animal leash apparatus. Shown throughout FIGS. 1-6 is an animal leash apparatus 100 in accordance with an illustrative embodiment of the invention.

In an embodiment of the present invention, the animal leash apparatus 100 may comprise an elongated flexible member 102, a clip 104, a handle 106, and an elongated outer member 108. In some embodiments, the elongated outer member 108 may be rigidly or elastically deformable; in preferred embodiments, the elongated outer member 108 may be elastically biased to recover a predetermined shape. In other embodiments, the elongated outer member 108 may be plastically deformable.

In an embodiment of the present invention, the elongated flexible member 102 may comprise metal materials, nylon materials, leather materials, cotton materials, or synthetic materials. For instance and without limitation, the elongated flexible member 102 may include a rope.

In an embodiment of the present invention, a cross-sectional shape of the elongated flexible member 102 may be flat or circular.

In an embodiment of the present invention, the clip 104 may comprise metal materials or plastic materials.

In an embodiment of the present invention, the clip 104 may be connected with a first or distal end of the elongated flexible member 102. The clip 104 may extend from the first or distal end of the elongated flexible member 102.

In an embodiment of the present invention, the clip 104 may be configured to be temporarily hooked with a collar or harness 200 on an animal.

In an embodiment of the present invention, the handle 106 may be a loop made of the same material as that of the elongated flexible member 102.

In an embodiment of the present invention, the handle 106 may comprise foam materials or other materials for padding.

In an embodiment of the present invention, the handle 106 may be connected with a second or proximal end of the elongated flexible member 102 opposite to the first or distal end of the elongated flexible member 102 at which the clip 104 is located.

In an embodiment of the present invention, the handle 106 may be configured to be grabbed by a user or human.

In an embodiment of the present invention, the elongated flexible member 102 may comprise rigid materials or semi-rigid materials.

In an embodiment of the present invention, the elongated flexible member 102 may be connected between the clip 104 and the handle 106.

In an embodiment of the present invention, the elongated flexible member 102 may be removably attached to the elongated outer member 108. In other embodiments, the elongated flexible member 102 and elongated outer member 108 may be permanently attached to one another.

In an embodiment of the present invention, the animal leash apparatus 100 may further comprise an adhesive disposed between the elongated flexible member 102 and the elongated outer member 108 for added durability.

In an embodiment of the present invention, the elongated outer member 108 may be located adjacent the clip 104, such that the elongated outer member 108 may be located closest to an animal when the clip 104 is hooked with the collar or harness 200. For instance, in some embodiments, such as the present embodiment, the elongated outer member 108 may extend proximally from the clip 104.

In an embodiment of the present invention, the animal leash apparatus 100 may be a tangle free leash apparatus, as the elongated outer member 108 may be stiffened or reinforced to minimize the tendency of a slackened leash to become entangled beneath a body of an animal. I.e., the elongated outer member 108 may be more rigid or less flexible than the elongated flexible member 102.

In an embodiment of the present invention, the elongated outer member 108 may allow an animal to walk freely by preventing the elongated flexible member 102 from getting tangled into the legs of an animal, or at least make the elongated flexible member 102 less likely to get stuck around the legs of an animal under the animal.

In an embodiment of the present invention, the elongated outer member 108 may provide rigidity to the elongated flexible member 102 such that the elongated flexible member 102 may be prevented from accidentally becoming tangled in the legs of an animal under the animal.

In an embodiment of the present invention, the elongated outer member 108 may be plastically deformable such that it is able to retain its shape when manually deformed.

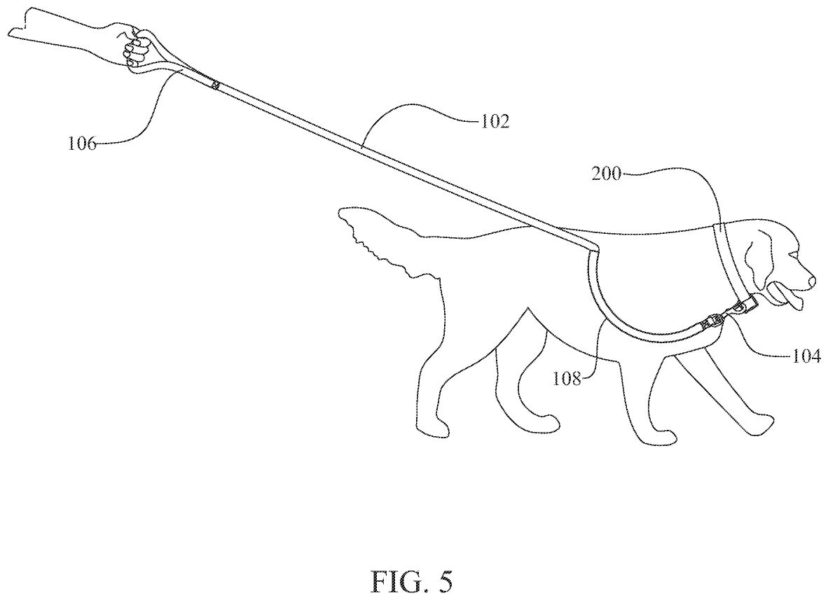

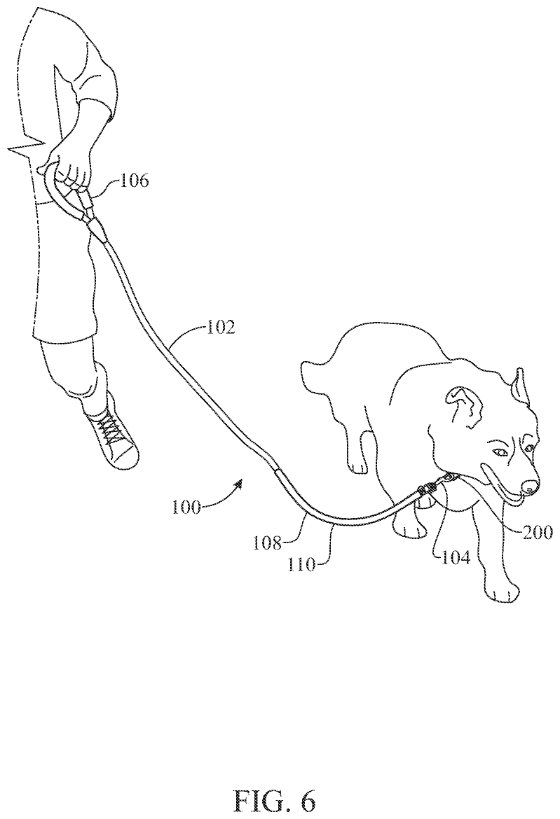

In an embodiment of the present invention, the elongated outer member 108 may be deformed to or configured with a predetermined shape. As best shown in FIGS. 5 and 6, which shows an example of curved or arched, predetermined shape, with animal leash apparatus 100 attached to a pet harness and the elongated outer member 108 in such predetermined shape, the elongated outer member 108 maintains the elongated flexible member 102 in the same predetermined shape and arranged extending away from the pet's legs, thereby preventing tangling of the animal leash apparatus 100 and interference of the animal leash apparats 100 with the pet's legs. In some embodiments, the predetermined shape may be an arched shape or a curved shape. In other embodiments, the predetermined shape may be straight. Further embodiments are contemplated in which the predetermined shape includes a combination of different shapes (e.g., curved and straight).

In some embodiments, such as the present embodiment, the elongated outer member 108 does not extend along the entire length of the elongated flexible member 102, but rather leaves a proximal portion of the elongated flexible member 102 uncovered and free to deform and flex normally, thereby maintaining easy and comfort of use of the elongated flexible member 102. In a non-limiting example, the elongated outer member 108 may extend along less than half of the total length of the elongate flexible member 102, as shown.

In an aspect of an embodiment of the present invention, the elongated outer member 108 may be an elongated rigidly deformable sheath, and the elongated flexible member 102 may be removably or permanently inserted into the elongated rigidly deformable sheath 108. In particular, in an embodiment of the present invention, the elongated outer member 108 may comprise an elongated tube 110, a lengthwise channel 112, and a lengthwise slit 114.

In an embodiment of the present invention, the lengthwise channel 112 may axially traverse through the elongated tube 110.

In an embodiment of the present invention, the lengthwise slit 114 may laterally traverse into the lengthwise channel 112.

In an embodiment of the present invention, the elongated flexible member 102 may be removably or permanently inserted into the lengthwise channel 112 through the lengthwise slit 114.

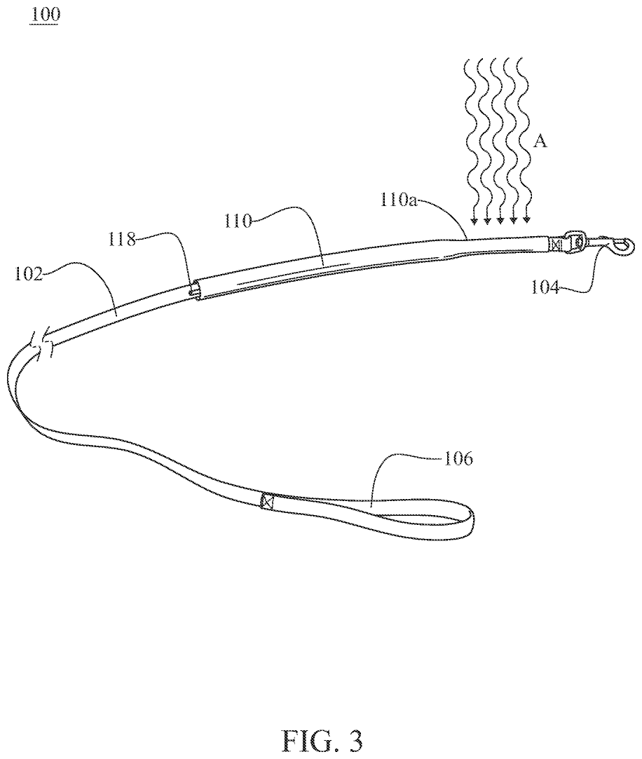

In an embodiment of the present invention, the elongated tube 110 may comprise heat-shrinkable plastic or rubber materials that may be heated and molded to the elongated flexible member 102. For instance, as shown in FIG. 3, the elongate tube 110 of the elongated outer member 108 may include a heat-shrink plastic tubing 110a; the elongated flexible member 102 may extend through the heat-shrink plastic tubing 110a and the heat-shrink plastic tubing 110a may be heat-shrunk, as indicated by arrows A, to conform to the elongated flexible member 102.

In an embodiment of the present invention, the elongated tube 110 may comprise PVC materials, polyolefin materials, polyethylene materials, or polypropylene materials or other plastic or rubber materials.

In an embodiment of the present invention, the elongated tube 110 may include plastic tube without a slit. The plastic tube may be applied during the initial assembly.

In an embodiment of the present invention, the elongated tube 110 may include at least one of a cold shrink tubing/solvent dilator tubing, a sealant layer (epoxy, RTV), a potting or rubbery type compound encapsulation, a dip coating layer, and a wrapped tape layer.

In an embodiment of the present invention, the elongated tube 110 may come in various colors and diameters, depending on the size and shape of the elongated flexible member 102.

In an embodiment of the present invention, the elongated outer member 108 may further comprise an elongated wire element 118.

In an embodiment of the present invention, the elongated wire element 118 may be removably or permanently inserted into the lengthwise channel 112 through the lengthwise slit 114.

In an embodiment of the present invention, the elongated wire element 118 may be encased in the elongated tube 110.

In an embodiment of the present invention, the elongated wire element 118 may be coupled to the elongated flexible member 102.

In an embodiment of the present invention, the elongated wire element 118 may be configured to provide rigidity to the elongated outer member 108. In some embodiments, the elongated wire element 118 may be elastically deformable. In other embodiments, the elongated wire element 118 may be plastically deformable to maintain the elongated outer member 108 in a selected, deformed position manually adjusted by the user. In some embodiments, the elongated tube 110 may be elastically deformable, and the plastically deformable, elongated wire element 118 may be configured to overcome the elastic biasing of the elongated tube 110 such that the elongated wire element 118 maintains the elongated tube 110 (and thus the elongated outer member 108) in a selected, deformed position manually adjusted by the user. Preferably, the user may manually adjust the elongated outer member 108, such as via the elongated wire element 118, to different selected deformed positions, such as to conform to a god shape or size. Once the elongated outer member 108 has been adjusted to a selected, deformed position, and in the absence of further forces by the user on the elongated outer member 108, the elongated outer member 108 may maintain its shape and provide a rigidity to the area of the elongated flexible member 102 along which the elongated outer member 108 is positioned.

In an embodiment of the present invention, the elongated wire element 118 may be inserted inside the elongated flexible member 102 prior to shrinkage.

In an embodiment of the present invention, the elongated wire element 118 may be thin and can be of various types of flexible metals.

In an embodiment of the present invention, the elongated wire element 118 may have the same length as that of the elongated tube 110.

In an embodiment of the present invention, a user may shape a section of the elongated flexible member 102 via the elongated wire element 118 to ensure that the elongated flexible member 102 stays away from legs of an animal.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. An animal leash apparatus comprising:
an elongated flexible member, comprising a proximal end and a distal end, wherein the proximal end is engageable by a user and the distal end is configured for attachment to a collar or harness wearable by a pet; and
an elongated outer member, extending along and imparting rigidity to an elongated, distal portion of the elongated flexible member; wherein
the animal leash apparatus is configured to adopt a working configuration in which the proximal end of the elongated flexible member is held by a user located adjacent to a pet wearing the collar or harness, and the distal end of the elongated flexible member is attached to the collar or harness, and further in which the elongated outer member is arranged in a predetermined shape extending away from the pet's legs and maintains the elongated flexible member along said predetermined shape and away from the pet's legs.

2. The animal leash apparatus of claim 1, wherein the elongated outer member is elastically deformable.

3. The animal leash apparatus of claim 2, wherein the elongated outer member is elastically biased to recover said predetermined shape.

4. The animal leash apparatus of claim 1, wherein the elongated outer member comprises a heat-shrink plastic tubing, wherein the elongated flexible member extends through the heat-shrink plastic tubing and the heat-shrink plastic tubing is heat-shrunk to conform to the elongated flexible member.

5. The animal leash apparatus of claim 1, further comprising a clip at the distal end of the elongated flexible member, wherein the clip is configured for attachment to the collar or harness.

6. The animal leash apparatus of claim 5, wherein the elongated outer member is located adjacent to the clip.

7. The animal leash apparatus of claim 6, wherein the elongated outer member extends proximally from the clip.

8. The animal leash apparatus of claim 1, further comprising a handle at the proximal end of the elongated flexible member.

9. The animal leash apparatus of claim 1, wherein the elongated outer member is formed as an outer sheath covering the distal portion of the elongated flexible member.

10. The animal leash apparatus of claim 9, wherein the elongated outer member comprises an elongated wire element imparting rigidity and deformability to the elongated outer member.

11. The animal leash apparatus of claim 9, wherein the elongated outer member comprises an elongated tube providing said outer sheath.

12. The animal leash apparatus of claim 11, wherein the elongated tube comprises a lengthwise slit, and further wherein the elongated outer member is mountable to the elongated flexible member by passing the elongated flexible member into the elongated tube through the lengthwise slit.

13. The animal leash apparatus of claim 11, wherein the elongated tube comprises a lengthwise slit, and further wherein the elongated outer member is removable from the elongated flexible member by passing the elongated flexible member out of the elongated tube through the lengthwise slit.

14. The animal leash apparatus of claim 11, wherein the elongated outer member comprises an elongated wire element imparting rigidity to the elongated tube, the elongated wire element encased within the elongated tube.

15. The animal leash apparatus of claim 14, wherein the elongated wire element is received within a lengthwise channel formed in the elongated tube.

16. The animal leash apparatus of claim 15, wherein the elongated wire element is removably received within the lengthwise channel and removably encased within the elongated tube.

17. The animal leash apparatus of claim 16, wherein the elongated tube comprises a lengthwise slit, and the elongated wire element is insertable and removable into and from the lengthwise channel through the lengthwise slit.

18. The animal leash apparatus of claim 1, further comprising an adhesive disposed between the elongated flexible member and the elongated outer member.

19. An animal leash apparatus comprising:
an elongated flexible member, comprising a proximal end and a distal end, wherein the proximal end is engageable by a user and the distal end is configured for attachment to a collar or harness wearable by a pet; and
an elastically deformable, elongated outer member, extending along and imparting rigidity to an elongated, distal portion of the elongated flexible member, the elongated outer member comprising a heat-shrink plastic tubing, wherein the elongated flexible member extends through the heat-shrink plastic tubing and the heat-shrink plastic tubing is heat-shrunk to conform to the elongated flexible member; wherein
the animal leash apparatus is configured to adopt a working configuration in which the proximal end of the elongated flexible member is held by a user located adjacent to a pet wearing the collar or harness, and the distal end of the elongated flexible member is attached to the collar or harness, and further in which the elongated outer member is arranged in a predetermined shape extending away from the pet's legs and maintains the elongated flexible member along said predetermined shape and away from the pet's legs; wherein
the elongated outer member is elastically biased to recover said predetermined shape, thereby elastically biasing the animal leash apparatus to said working configuration.

20. An animal leash apparatus comprising:
an elongated flexible member, comprising a proximal end and a distal end, wherein the proximal end is engageable by a user and the distal end comprises a clip configured for attachment to a collar or harness wearable by a pet; and
an elastically deformable, elongated outer member, extending along and imparting rigidity to an elongated, distal portion of the elongated flexible member, the elongated outer member arranged adjacent to the clip and comprising a heat-shrink plastic tubing, wherein the elongated flexible member extends through the heat-shrink plastic tubing and the heat-shrink plastic tubing is heat-shrunk to conform to the elongated flexible member; wherein
the animal leash apparatus is configured to adopt a working configuration in which the proximal end of the elongated flexible member is held by a user located adjacent to a pet wearing the collar or harness, and the distal end of the elongated flexible member is attached to the collar or harness, and further in which the elongated outer member is arranged in a predetermined shape extending away from the pet's legs and maintains the elongated flexible member along said predetermined shape and away from the pet's legs; wherein
the elongated outer member is elastically biased to recover said predetermined shape, thereby elastically biasing the animal leash apparatus to said working configuration.
